(19) United States
(12) Patent Application Publication
(10) Pub. No.: US 2003/0146165 A1
(43) Pub. Date: Aug. 7, 2003

(54) Treatment agent and method for elimination of harmful polluted substances

(76) Inventors: Toshiaki Katsube, Hiroshima-shi (JP); Hatsuo Oyaizu, Shizuoka-ken (JP)

Correspondence Address: REED SMITH LLP, Suite 1400, 3110 Fairview Park Drive, Falls Church, VA, 22042, US

(21) Appl. No.: 10/173,649

(22) Filed: Jun. 19, 2002

(30) Foreign Application Priority Data
Jun. 19, 2001 (JP) 2001-185478

(51) Int. Cl. C02F 1/48

(52) U.S. Cl. 210/695; 502/180; 502/174

(57) ABSTRACT

A treatment agent for elimination of contaminated harmful substances, essentially comprised of high osmotic water prepared by fining treatment of water molecule cluster and activated carbon in the form of highly carbonaceous and porous fine powder mixed with the high osmotic water.

### BACKGROUND OF THE INVENTION

1. Field of the Invention

The present invention relates to a treatment agent for eliminating harmful substances in contaminated soil, incineration ash or the like and a method of eliminating harmful substances from the soil, incineration ash or the like.

2. Description of the Prior Art

Recently, the contamination problems of soil, remaining incineration ash, and ground water caused by harmful substances such as PCB (Polychlorinated biphenyls), PCDD (Dioxins) leaked or scattered from the places in the vicinity of a factory or garbage incineration facility and the site of the demolished factory or garbage incineration facility have become the critical issue, requiring development of an effective method of eliminating harmful substances. Currently, various methods of eliminating harmful substances are proposed with substantial results.

Since the soil, incineration ash, and ground water contaminated with such harmful substances range extensively, it is required to provide a method capable of eliminating harmful substances in the wide contaminated area in a simple manner and at a low cost. It is, however, actual circumstances that such effective elimination method with simple and low cost is not yet developed.

### SUMMARY OF THE INVENTION

It is, therefore, a primary object of the present invention to provide a treatment agent capable of effectively eliminating harmful substances in an extensively contaminated area at a low cost.

Another object of the present invention is to provide a method of eliminating harmful substances in a simple manner by using the treatment agent of harmful substances.

According to the present invention, the primary object is accomplished by providing a treatment agent for elimination of contaminated harmful substances, essentially comprised of high osmotic water prepared by fining treatment of water molecule cluster and activated carbon in the form of highly carbonaceous and porous fine powder mixed with the high osmotic water.

In the treatment agent, it is preferable that the ratio in capacity of the high osmotic water relative to the activated carbon is defined in a range of 5:10-100:30, and it is also preferable that the high osmotic water is in the form of an aqueous solution prepared by mixing 35 wt % to 55 wt % carbinol with carbon number 2-4 into water treated in a strong magnetic field in such a manner that the water molecular cluster in the aqueous solution is fined down and fused with the carbinol molecule. Preferably, the activated carbon is in the form of a highly carboneous and porous activated carbon whose carbonation rate is more than 90%, specific area is more than 1000 m²/g, and pH is 9.0 to 11.0.

The contaminated harmful substances treated by the treatment agent are various kinds of harmful chemical substances included in contaminated soil or incinerated ash such polychlorinated biphenyl, dioxin, heavy metals and other organic or non-organic substances.

In a method of eliminating harmful substances includes in contaminated soil or incinerated ash, it is preferable that the treatment agent according to the present invention is sprayed on the contaminated soil or incinerated ash. More preferably, water is sprayed on the contaminated soil or incinerate ash after the treatment agent was sprayed on the same.

The high osmotic water used for the treatment agent is a functional water proposed by one of the inventors in Japanese Patent Application No. 2001-146519. The pH of the functional water is in a range of 7.0-7.5, and the specific weight of the functional water is in 0.95-0.097. The functional water is fire-resistant without chemical response to added substances. The high osmotic water has extremely high permeability in soil, wood materials, stone materials, plastics and other solid materials and is effective to induce various kinds of liquids and fine solid powders into wood materials, soil layers, ceramic materials, plastic materials, stone materials, etc.

On the other hand, the activated carbon is in the form of a highly carboneous and porous fine powder of activated carbon whose carbonation rate is more than 90%, specific surface area is 1000 m²/g, and pH is in a range of 9.0-11.0. In comparison with a usual activated carbon, the activated carbon used in the treatment agent has a high carbonation rate, a high specific surface area, and a special pH region. The activated carbon has an internal structure with countless continuous fine holes and has an absorption function effective to various kinds of substances. With respect to the internal structure, the activated carbon has a function passing therethrough a minimum molecular group of water molecule cluster, and with respect to the physical characteristics, it has a function forming an electromagnetic field to induct a free electron (−e) from its circumference and to eliminate a positive ion (+e), and it has a function generating a large amount of radiation wave with specific frequency.

In use of the treatment agent according to the present invention, the high osmotic water causes the fine particles of the activated carbon to permeate into the soil layer or incineration ash and to widely and deeply disperse them thereby to absorb, decompose and degenerate a large amount of harmful substances for elimination of them.

In the case that the treatment agent is mixed with contaminated soil or incineration ash, the material induction function of the high osmotic water causes the mixed fine particles of the activated carbon into the soil layer or incineration ash and to widely and deeply dispose them thereby to absorb, decompose and degenerate a large amount of harmful substances for elimination of them.

In an elimination method of contaminated harmful substances in accordance with the present invention, the treatment agent is sprayed on or mixed with layers of contaminated soil or incineration ash. In such an instance, the treatment agent does not disperse due to wind except for strong wind since the fine particles of the activated carbon in the treatment agent has a high osmotic property. After sprayed, the material induction function of the high osmotic water causes the fine particles of the activated carbon into the soil layer or incineration ash and to widely and deeply disperse them thereby to absorb, decompose and degenerate a large amount of harmful substances for elimination of them.

### BRIEF DESCRIPTION OF THE DRAWINGS

In the drawings:

FIG. 1 is a schematic illustration of a production system for preparing high osmotic water to be used for a treatment agent of harmful substances in accordance with the present invention.

### DESCRIPTION OF THE PREFERRED EMBODIMENTS

A treatment agent of harmful substances according to the present invention includes high osmotic water and highly carbonaceous and porous fine particles of activated carbon that are mixed in the high osmotic water as main components.

The high osmotic water contained in such treatment agent is prepared by fining treatment of water molecule cluster. Actually, the water molecular cluster in fined state is fused into carbinol such as ethyl alcohol, isopropyl alcohol or the like to be stabilized.

In an example for preparation of such high osmotic water, an aqueous solution to be treated was prepared by mixing 35 wt % to 55 wt % carbinol with carbon number 2 to 4 into pure water, purified water or general water treated in a strong magnetic field. The prepared aqueous solution was stirred under a sprayed condition at a temperature less than 10° C. to fine down the water molecular cluster in the aqueous solution. Thereafter, the water molecular cluster of fined state was fused with the carbinol molecule at a temperature of from 80° C. to 83° C. Thus, the high osmotic water was prepared in a condition where the water molecule cluster is stably maintained in a fined state for a long period of time. The high osmotic water prepared in such a manner has a high osmotic function caused by the water molecule cluster in the fined state and also has a material induction function with which various kinds of liquid or solid substances in the form of fine powder are induced in a soil layer, incineration ash layer or the like.

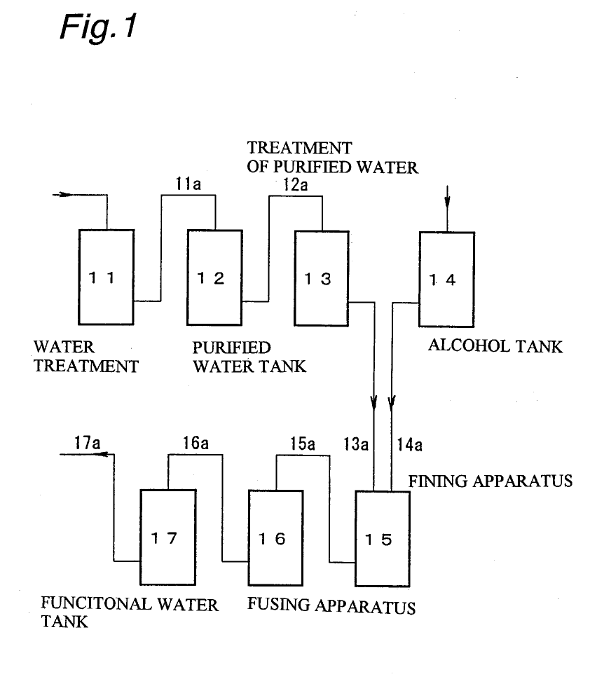

In FIG. 1, there is schematically illustrated a system for preparation of the high osmotic water, wherein carbinol such as ethylalcohol (industrial alcohol allowed), isopropyl alcohol (industrial alcohol allowed) is mixed with pure water, highly purified water or general water such as tap water (tap water allowed) to prepare the high osmotic water.

The preparation system shown in FIG. 1 comprises a water treatment apparatus 11, a reservoir tank 12 of purified water, a treatment apparatus 13 of purified water, a reservoir tank 14 of alcohol, a fining apparatus 15 of water molecule cluster, a fusing apparatus 16 of water molecule cluster, and a reservoir tank 17 of functional water (a reservoir tank of high osmotic water). Those apparatuses and reservoir tanks are connected each other through supply conduits 11a to 16a equipped with a supply pump respectively.

The water treatment apparatus 11 includes a compound filtering system composed of activated carbon material and medical filtering fibers for filtering the supplied tap water to produce purified water with purification degree of more than 98%. The purified water is supplied into the reservoir tank 12 through the water supply conduit 11a. In the water treatment apparatus 11, the compound filtering system may be replaced with an ion exchange system containing ion exchange resin in necessity, thereby making it possible to prepare the purified water as pure water or highly purified pure water.

The treatment apparatus 13 of purified water is supplied with the purified water from the reservoir tank 12 and supplies the purified water to the fining apparatus 15 through a strong magnetic field region. The treatment apparatus 13 includes an activated carbon layer which forms the strong magnetic field by function of a permanent magnet embedded therein. Thus, the activated carbon layer acts to change revolution of the water molecule cluster passing therethrough thereby to enhance the fining function of the water molecule cluster in the following fining process and to enhance the bonding function of the water molecule cluster with alcohol molecule in the further following process.

The fining apparatus 15 is supplied with the purified water treated in the strong magnetic field from the treatment apparatus 13 and with alcohol from the alcohol reservoir tank 14. In the fining apparatus 15, the purified water treated in the strong magnetic field is mixed and stirred with the alcohol to fine the water molecule cluster. The fining apparatus 15 includes a spray nozzle connected to conduits 13a and 14a for supply of the purified water and alcohol and a motor-driven agitator. In the fining apparatus 15, the purified water and alcohol are supplied into the spray nozzle at a specified ratio, for instance, at a ratio of 35 wt % to 55 wt % alcohol to the purified water and supplied from the spray nozzle into the fining apparatus 15 in a sprayed condition. The purified water and alcohol in the sprayed condition are uniformly mixed by operation of the agitator to fine the water molecule cluster.

In the preparation system, the capacity of the fining apparatus 15 is determined in an amount of 150L, and the agitator is driven at 1000 r. p. m. for 10 minutes after supplied with a full amount of the purified water and alcohol to fine the water molecule cluster thereby to obtain treated liquid of 100L.

The fusing apparatus 16 is provided to fuse the fined water molecule cluster and alcohol molecule by heating and stirring the treated liquid supplied from the fining apparatus 15. The fusing apparatus includes an electric heater and a motor-driven agitator. The treated liquid supplied from the fining apparatus 15 through the conduit 15a is heated by the electric heater in a stirred condition in the fusing apparatus 16 to cause fusion of the water molecule cluster and alcohol molecule. In such fusion, the fined water molecule cluster introduces the alcohol molecule therein and is stably maintained in a fined condition for a long period of time.

In the preparation system, the capacity of the fusing apparatus 16 is determined in an amount of 150L, and the agitator is driven at 500 r. p. m. and heated in a range of 82 to 105° C. to cause fusion of the treated liquid supplied therein. In operation of the fusing apparatus 15, the stirring and heating stopped to cool the treated liquid at a time when the temperature of the treated liquid rises up to a fusion temperature (80 to 83° C.) or after lapse of a predetermined time (several 10 minutes). Thus, the high osmotic water is prepared in the fusing apparatus 16 and supplied into and stored in the reservoir tank 17 of functional water through the conduit 16a. The high osmotic water stored in the reservoir tank 17 of functional water is taken out through a discharge conduit 17a in necessity.

The highly carbonaceous and porous activated carbon used for the treatment agent is in the form of a highly carbonaceous and porous activated carbon whose carbonation rate is more than 90%, specific surface area is more than 1000 m²/g, and pH is 9.0 to 11.0. The activated carbon is produced by the steps of smoking palm shell and sawdust in a usual carbonation process for manufacturing palm shell charcoal and heating the smoked charcoal in a vacuum condition for several hours.

In this instance, the heating treatment temperature is controlled to be maintained at a temperature of 1000 to 1300° C. to prepare an activated carbon the carbonation rate of which is 90 to 96% and the specific surface area of which is more than 1000 m²/g, preferably more than 1200 m²/g. An activated carbon the specific surface area of which is up to 2000 m²/g can be prepared by control of the heating treatment temperature.

The ratio of the high osmotic water relative to the highly carbonous and porous activated carbon fine powder in the treatment agent is appropriately determined in accordance with the contaminated soil, a pollution degree of incinerated ash, and osmotic condition to the soil and incineration ash. The ratio of these capacities is in a range of 5:10 to 100:30.

In comparison with the usual activated carbon, the activated carbon has a high carbonation rate, a high specific surface area, and a special pH region. In this respect, it is presumed that, with respect to the internal structure, the activated carbon has an internal structure with countless continuous fine holes and has an absorption function effective to various kinds of substances. With respect to the internal structure, the activated carbon has a function passing therethrough a minimum molecular group of water molecule cluster, and with respect to the physical characteristics, it has a function forming an electromagnetic field to induct a free electron (−e) from its circumference and to eliminate a positive ion (+e), and it has also a function generating a large amount of radiation wave with specific frequency.

Accordingly, the high osmotic water in the treatment agent is effective to induce the fine particles of the activated carbon into the soil and incineration ash together with its high osmotic functions and its internal structure function and to cause wide dispersion and deep permeation of them. Thus, the fine particles of the activated carbon widely and deeply dispersed in the soil and incineration ash acts to absorb a large amount of harmful substances widely dispersed in the soil and incineration ash and to decompose or degenerate the absorbed harmful substances into harmless substances.

As the harmful substances in the soil and incineration ash, there are polychlorinated biphenyl (PCB), dioxin (PCDD), and other organic chlorinated compounds such as dichloromethane, dichloroethane, trichloroethane, tetrachloroethylene, dichloropropane, organic phospher compounds, cyanic compounds, cadmium, lead, arsenic, mercury, etc. The treatment agent acts effectively against such harmful substances.

A first elimination method of harmful substances to which the treatment agent is used is to spray the treatment agent on the contaminated soil layer or incineration ash layer. A second elimination method of harmful substances is to dug up the contaminated soil layer and to spray the treatment agent on the soil group for mixing with the same or to collect the contaminated incineration ash and to spray the treatment agent on the collected incineration ash for mixing with the same.

Although in the first elimination method, the treatment agent is sprayed on the soil layer or incineration ash layer in the field, the treatment agent does not disperse due to wind except for strong wind since the fine particles of the activated carbon in the treatment agent has a high osmotic property. After sprayed, the material induction function of the high osmotic water causes to permeate the fine particles of the activated carbon into the soil layer or incineration ash and to widely and deeply disperse them thereby to absorb, decompose, and degenerate a large amount of harmful substances for elimination of them.

In this instance, it is preferable to spray more water on the soil layer or incineration ash layer on which the treatment agent has been sprayed. If the water is sprayed on the soil layer or incineration ash layer on which the treatment agent has been sprayed, the high osmotic water that has been sprayed on and permeated into the soil layer or incineration ash layer causes the sprayed water to rapidly permeate into the soil layer or incineration ash layer and simultaneously causes the fine particles of the activated carbon to more deeply and widely disperse into the soil layer or incineration ash layer.

In the second elimination method, the treatment agent is sprayed on the dug soil layer or accumulated incineration ash layers indoor or in the field for mixing with them. In this instance, the treatment agent does not disperse due to wind except for strong wind since the fine particles of the activated carbon in the treatment agent has a high osmotic property. After mixed with the dug soil layer or accumulated incineration ash layers, the material induction function of the high osmotic water causes to permeate the mixed fine particles of the activated carbon into the soil layer or incineration ash and to widely and deeply disperse them thereby to absorb, decompose, and degenerate a large amount of harmful substances for elimination of them.

Embodiment 1:

In this embodiment, an experiment was conducted to confirm the function of the highly carbonaceous and porous activated carbon for eliminating various kinds of harmful substances. In this experiment, highly carbonaceous and porous activated carbon whose carbonation rate is 95%, specific surface area is 1500 m²/g, and pH is 9.5 was adapted as a testing agent of activated carbon. In addition, contaminated field soil (a testing sample body 1), contaminated soil filled with incinerated ash (a testing sample body 2), contaminated discharge water (a testing sample body 3), contaminated soil in a factory (a testing sample body 4), and contaminated soil of another factory (a testing sample body 5) were used as testing sample bodies.

The testing sample body 1 contained therein hexachrome. The testing sample body 1 of 1 kg was added with water of 1 L and the testing treatment agent of 33 cc and stirred gently for twenty minutes. After treated for elimination of harmful substances, the testing sample body 1 was filtered with No 5c filter paper to measure an amount of hexachrome contained in the filtered liquid. The measurement was conducted on a basis of a notice No. 13 of the Environment Bureau.

The testing sample body 2 contained therein arsenic, lead, cadmium, mercury, chrome, and cyanic compounds. The testing sample body 2 was treated in the same manner as in the sample body 1 to measure components contained in the filtered liquid. The measurement was carried out by according to the DDTC-Ag photo-absorption method for the arsenic, according to atomic photo-absorption method for the lead and cadmium, according to the reduction vapor atomic absorption method for mercury, according to diphenylcarbadide absorptiometry for all chromes, and pridine-pyrozolone absorptiometry for cyanic compounds.

The testing sample body 3 contained therein PCB. The testing sample body 3 of 350 cc was added with the testing treatment agent of 40 cc and stirred gently. After treated for elimination of harmful substances respectively for one hour, two hours and three hours, an amount of PCB in the treated liquid was measured. The measurement was conducted on a basis of JIS K0102 (the notice No. 59 of the Environment Bureau, 1970)

The testing sample body 4 contained therein trichloroethylane and tetrachloroethylane. The testing sample body 4 of 350 cc was added with water of 200 cc and the testing treatment agent of 40 cc. The mixture of the testing sample body 4 with the water and testing treatment agent was applied to an elution test according to a notice No. 46 of the Environment Bureau to measure constituent in the eluate. The measurement was carried out on a basis of JIS K0125 5.2 (Head space gas-chromatograph mass spectrometry).

The testing sample body 5 contained therein benzene. The testing sample body 5 of 100 cc was added with water of 50 cc and the testing treatment agent of 3 g. The mixture of the testing sample body 5 with the water and testing treatment agent was applied to the elution test according to a notice No. 46 of the Environment Bureau to measure the benzene in the eluate. The measurement was carried out on a basis of JIS K0125 5.2 (Head space gas-chromatograph mass spectrometry).

Listed in the following Table 1 are the contamination density caused by harmful substances in each testing sample body adapted in the foregoing experiments and the contamination density caused by harmful substances after the elimination treatment using the testing treatment agent. Provided in the Table 1, “Cyanic” in the column of contamination substance represents the cyanic compounds, “PCB(1), PCB(2), PCB(3)” represents the fact that the treatment time of the PCB (Polychlorinated biphenyl) is one hour, two hours, and three hours, “TC ethylene” represents the trichloroethylene, and “TeC ethylene” represents the tetrachloroethylene, respectively. In addition, “ND” in the column of the contamination density after treatment represents less than a lower limit of detection, and “0.0005 mg/L” represents less than 0.0005 mg/L.

TABLE 1

| | Contaminated | Contaminated desity | | | |
|---|---|---|---|---|---|
| Sample body | substance | Before treatment | | After treatment | |
| 1 | Hexachrome | 100 | ppm | ND | |
| 2 | Arsenic | 3.30 | μg/g | ND | |
| | Lead | 390.0 | μg/g | ND | |
| | Cadmium | 14.3 | μg/g | ND | |
| | Mercury | 0.024 | μg/g | ND | |
| | Chrome | 120.0 | μg/g | ND | |
| | Cyanic | 0.05 | μg/g | ND | |
| 3 | PCB(1) | 0.145 | mg/L | 0.0025 | mg/L |
| | PCB(2) | 0.145 | mg/L | 0.0005 | mg/L |
| | PCB(3) | 0.145 | mg/L | 0.0005 | mg/L |
| 4 | TC ethylene | 2.0 | mg/L | 0.009 | mg/L |
| | TeC ethylene | 0.0022 | mg/L | 0.0005 | mg/L |
| 5 | Benzene | 742 | ppm | 0.005 | ppm |

The activated carbon used as a testing agent in this experiment is an activated carbon comprised of the treatment agent according to the present invention. As shown in Table 1, it has been confirmed that the activated carbon has quite high absorption functions, decomposition functions, denaturation functions against many kinds of heavy metal non-organic compounds, PCB, and many kinds of organic solvent that cause contamination of soil or ground water contamination. Therefore, it has been found that the activated carbon is quite effective to eliminate contamination substances in the contaminated soil, incineration ash and ground water.

Embodiment 2:

In this embodiment, an experiment was conducted to confirm the elimination functions against PCB in soil contaminated with PCB by using the treatment agent according to the present invention. In this experiment, plural kinds of treatment agent in the form of a mixture of high osmotic water and highly carbonous and porous activated carbon were used as a testing agent. The activated carbon containing each testing agent was a highly carbonous and porous activated carbon whose carbonation rate is 95%, specific surface area is 1500 m²/g and pH is 9.5. In addition, the high osmotic water containing the testing agent included a component of carbitol with carbon number of 2 to 4 and water. The water molecule cluster in fined state is a stable condition fused with the carbitol where pH is in the range of 7.0 to 7.5 and the specific weight is in the range of 0.95 to 0.97. The water molecule cluster was fire-resistant without chemical response to the added agent.

The testing body to be treated was a contaminated soil that was artificially prepared by using PCB. The contamination degree of the soil was in the range of less than 1 ppm to less than 1000 ppm. The contaminated soil was filled into the cubic frame of 1 m in height and width to produce a plurality of cubic contaminated soil layer of 1 m in height, width and depth. The treatment agent was sprayed onto the formed testing body, and the same amount of tap water as the treatment agent was sprayed and allowed to stand for 30 minutes to confirm sufficiently permeated condition of the treatment agent into the testing body. After lapse of 30 minutes, a sample was taken out from appropriate 10 positions of the respective testing bodies, and the samples were mixed uniformly for measurement of PCB contained therein. The measurement of PCB was conducted according to the gas chromatography (Bottom sediment research method II15).

In this experiment, the relationship between the composition of the treatment agent and the amount of PCB (degree of pollution) in the contaminated soil before elimination thereof was observed at a time point where PCB is seized, decomposed, and degenerated for elimination until PCB becomes less than a minimum level of detection. Listed in the following Table 2 is a result of the observation.

In Table 2, PW in the composition ratio of the testing agent (PW:NC) represents the high osmotic water in the treatment agent according to the present invention, NC represents the highly carbonous and porous activated carbon in the treatment agent according to the present invention. In addition, the spraying ratio represents the ratio of the testing agent (treatment agent) sprayed on the contaminated soil, and the required spraying amount (ton) represents the spraying amount (weight) of the treatment agent required in an actual minimum disposal scale (contaminated soil of 100 m³).

TABLE 2

| Contaminated | Composition ratio | | Required |
|---|---|---|---|
| degree of soil | of treatment agent | Sprayed ratio | spraying amount |
| (ppm) | (PW:NC) | (%) | (ton) |
| less than 1 | 5:10 | 3 | 3/100 m³ |
| less than 5 | 5:10 | 3 | 3/100 m³ |
| less than 10 | 10:20 | 5 | 5/100 m³ |
| less than 20 | 10:20 | 5 | 5/100 m³ |
| less than 30 | 10:20 | 6 | 6/100 m³ |
| less than 40 | 10:20 | 10 | 10/100 m³ |
| less than 50 | 20:20 | 10 | 10/100 m³ |
| less than 60 | 20:20 | 15 | 15/100 m³ |
| less than 70 | 50:20 | 15 | 15/100 m³ |
| less than 80 | 50:20 | 15 | 15/100 m³ |
| less than 90 | 50:20 | 20 | 20/100 m³ |
| less than 100 | 100:20 | 20 | 20/100 m³ |
| less than 150 | 100:20 | 25 | 25/100 m³ |
| less than 200 | 100:20 | 30 | 30/100 m³ |
| less than 300 | 100:20 | 40 | 40/100 m³ |
| less than 500 | 100:30 | 50 | 50/100 m³ |
| less than 1000 | 100:30 | 60 | 60/100 m³ |

As shown in Table 2, it has been confirmed that the treatment agent according to the present invention has a quite high functions capable of seizing, decomposing, and degenerating PCB from the soil contaminated with PCB. Therefore, it has been found that the treatment agent is quite effective for eliminating PCB from the soil contaminated with PCB. In this case, it is possible to dispose a large amount of contaminated soil with a small amount of treatment agent by preparation of the treatment agent at a composition ratio in accordance with the degree of pollution of the soil.

Embodiment 3:

In this embodiment, an experiment was conducted to confirm the elimination functions against the dioxin in the incineration ash contaminated with dioxin by using the treatment agent according to the present invention. In this experiment, the treatment agent was prepared as a testing agent by mixing high osmotic water with highly carbonous and porous activated carbon at ratio of 2:1. The activated carbon and high osmotic water in the testing agent were the same as those used in the embodiment 2.

In this experiment, incineration ash contaminated with dioxin was collected and filled in a cubic frame of 1 m in height, width and depth to prepare a plurality of cubic testing bodies. The testing agent of 100 L was sprayed uniformly onto the testing bodies and allowed to stand for 30 minutes until the testing agent sufficiently permeates into the testing bodies. After lapse of 30 minutes, samples were taken out from appropriate 10 positions of the testing bodies and mixed uniformly for measurement of dioxin contained therein. The measurement of dioxin was conducted according to the chromatograph measurement method. Listed in the following Tables 3, 4, 5, and 6 are results of the experiment.

In Table 3, TeCDF in dibenzofuran represents 2,3,7,8-TeCDF, PeCDF(1) represents 1,2,3,7,8-PeCDF, PeCDF(2) represents 2,3,4,7,8-PeCDF, HxCDF(1) represents 1,2,3,4,7,8-HxCDF, HxCDF(2) represents 1,2,3,6,7,8-HxCDF, HxCDF(3) represents 1,2,3,6,7,8,9-HxCDF, HxCDF(4) represents 2,3,4,6,7,8-HxCDF, HpCDF(1) represents 1,2,3,4,6,7,8-HpCDF, and PCDFs represents 2,3,7,8-PCDFs.

In Table 4, TeCDD represents 2,3,7,8-TeCDD, PeCDD represents 1,2,3,7,8-PeCDD, HxCDD(1) represents 1,2,3,4,7,8-HxCDD, HxCDD(2) represents 1,2,3,6,7,8-HxCDD, HxCDD(3) represents 1,2,3,7,8,9-HxCDD, HpCDD represents 1,2,3,4,6,7,8-HpCDD, and PCDDs represents 2,3,7,8-PCDDs.

In Tables 3 and 4, TEQ value represents toxic equivalent quantity in terms of 2,3,7,8-TCDD.

TABLE 3

| | Measured value | | | TEQ value | | |
|---|---|---|---|---|---|---|
| | Density (pg/g) | | | Density (pg-TEQ/g) | | |
| Dibenzofuran | Before | After | Decomposition | Before | After | Decompositon |
| (Isomer) | treatment | treatment | rate (%) | treatment | treatment | rate (%) |
| TeCDF | 880 | 55 | 93.8 | 88 | 5.5 | 93.6 |
| PeCDF(1) | 3200 | 85 | 97.3 | 160 | 4.3 | 97.3 |
| PeCDF(2) | 4100 | 71 | 98.3 | 2000 | 36 | 98.2 |
| HxCDF(1) | 3800 | 81 | 97.9 | 380 | 8.1 | 97.9 |
| HxCDF(2) | 3300 | 72 | 97.8 | 330 | 7.2 | 97.8 |
| HxCDF(3) | 1500 | 14 | 99.1 | 150 | 1.4 | 99.1 |
| HxCDF(4) | 4500 | 92 | 98.0 | 450 | 9.2 | 98.0 |
| HpCDF(1) | 23000 | 140 | 99.4 | 230 | 1.4 | 99.4 |
| HpCDF(2) | 1500 | 43 | 97.1 | 15 | 0.4 | 97.1 |
| OCDF | 9700 | 160 | 98.4 | 1 | 0.0 | 98.4 |
| Total | 55480 | 813 | 98.5 | 3804 | 73.5 | 98.1 |
| PCDFs | | | | | | |

TABLE 4

| | Measured value | | | TEQ value | | |
|---|---|---|---|---|---|---|
| | Density (pg/g) | | | Density (pg-TEQ/g) | | |
| Dioxine | Before | After | Decomposition | Before | After | Decomposition |
| (Isomer) | treatment | treatment | rate (%) | treatment | treatment | rate (%) |
| TeCDD | 310 | 8.8 | 97.2 | 310 | 8.8 | 97.2 |
| PeCDD | 2500 | 38 | 98.5 | 2500 | 38 | 98.5 |
| HxCDD(1) | 2600 | 35 | 98.7 | 260 | 3.5 | 98.7 |
| HxCDD(2) | 5300 | 90 | 98.3 | 530 | 9.0 | 98.3 |
| HxCDD(3) | 3200 | 70 | 97.8 | 320 | 7.0 | 97.8 |
| HpCDD | 33000 | 490 | 98.5 | 330 | 4.9 | 98.5 |
| OCDD | 65000 | 710 | 98.9 | 7 | 0.071 | 98.9 |
| Total | 111910 | 1442 | 98.7 | 4257 | 71.3 | 98.3 |
| PCDDs | | | | | | |

TABLE 5

| | Measured value | | |
|---|---|---|---|
| | Density (pg/g) | | |
| Dibenzofuran | Before | After | Decomposition |
| (Homologue) | treatment | treatment | rate (%) |
| TeCDFs | 49000 | 1900 | 96.1 |
| PeCDFs | 44000 | 1100 | 97.5 |
| HxCDFs | 40000 | 820 | 98.0 |
| HpCDFs | 29000 | 340 | 98.8 |
| OCDF | 97000 | 160 | 98.4 |
| Total PCDFs | 171700 | 4320 | 97.5 |

TABLE 6

| | Measured value | | |
|---|---|---|---|
| | Density (pg/g) | | |
| Dioxine | Before | After | Decomposition |
| (Homologue) | treatment | treatment | rate (%) |
| TeCDDs | 32000 | 1600 | 95.0 |
| PeCDDs | 58000 | 1600 | 97.2 |
| HxCDDs | 70000 | 2100 | 97.0 |
| HpCDDs | 61000 | 1000 | 98.4 |
| OCDD | 65000 | 710 | 98.9 |
| Total PCDDs | 286000 | 7010 | 97.5 |

As shown in these Tables, the measured density of 2,3,7,8-Chlor-substituted dibenzofuran (2,3,7,8-PCDFs) for toxic evaluation was reduced from 55480pg to 813pg per 1 g, with the decomposition rate being 98.5%. In the toxic equivalent quantity (TEQ), it was reduced from 3804pg-TEQ/g to 73.5pg-TEQ/g, with the decomposition rate being 98.1%. On the other hand, similar results were obtained in 2,3,7,8-Chlor-substituted dioxin (2,3,7,8-PCDDs). The measured density was reduced from 111910 pg per 1 g to 1442pg, with the decomposition rate being 98.7%. In the toxic equivalent quantity (TEQ), it was reduced from 4257pg-TEQ/g to 71.3pg-TEQ/g, with the decomposition rate being 98.3%.

The density of entire isomers other than 2,3,7,8-Chlor-sustitution product or the decomposition rate of homologue density was 96.1% to 98.8% in polychlorinasted dibenzofuran (PCDFs) and 97.5% in total density. The similar decomposition rate was confirmed for dioxin (PCDDs). Since this decomposition rate is approximately the same as in the 2,3,7,8-Chlor-sustitution product, it is assumed that 2,3,7,8-Chlor-sustitution product and other homologue are decomposed almost at the same rate. As described above, it has been confirmed that the treatment agent according to the present invention is extremely effective to eliminate dioxin in the incineration ash layer.

What is claimed is:

1. A treatment agent for elimination of contaminated harmful substances, essentially comprised of high osmotic water prepared by fining treatment of water molecule cluster and activated carbon in the form of highly carbonaceous and porous fine powder mixed with the high osmotic water.

2. A treatment agent for elimination of contaminated harmful substances as claimed in claim 1, wherein the ratio in capacity of the high osmotic water relative to the activated carbon is defined in a range of 5:10-100:30.

3. A treatment agent for elimination of contaminated harmful substances as claimed in claim 1, wherein the high osmotic water is in the form of an aqueous solution prepared by mixing 35 wt % to 55 wt % carbinol with carbon number 2-4 into water treated in a strong magnetic field in such a manner that the water molecular cluster in the aqueous solution is fined down and fused with the carbinol molecule.

4. A treatment agent for elimination of contaminated harmful substances as claimed in claim 1, wherein the activated carbon is in the form of a highly carboneous and porous activated carbon whose carbonation rate is more than 90%, specific surface area is more than 1000 m²/g, and pH is 9.0 to 11.0.

5. A treatment agent-for elimination of contaminated harmful substances as claimed in claim 1, the contaminated harmful substances to be eliminated are harmful chemical substances included in contaminated soil or incinerated ash.

6. A treatment agent for elimination of contaminated harmful substances as claimed in claim 1, the contanminated harmful substances to be eliminated are polychlorinated biphenyl or dioxin included in contaminated soil or incineration ash.

7. A method of eliminating harmful substances included in contaminated soil or incinerated ash, wherein the treatment agent claimed in claim 1 is sprayed on the contaminated soil or incinerated ash.

8. A method of eliminating harmful substances included in contaminated soil or incinerated ash, wherein water is sprayed on contaminated soil or incinerated ash after the treatment agent claimed in claim 1 was sprayed on the same.

9. A method of eliminating harmful substances includes in contaminated soil or incinerated ash, wherein the treatment agent claimed in claim 1 is mixed with the contaminated soil or incinerated ash.
